(19) United States
(12) Patent Application Publication
(10) Pub. No.: US 2004/0246519 A1
(43) Pub. Date: Dec. 9, 2004

(54) Methods and apparatus for controlling a thermal conditioning device

(76) Inventors: Howard Gaines Hooper III, Boise, ID (US); Dean Richtsmeier, Boise, ID (US); Eric Unger Eskey, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/457,497

(22) Filed: Jun. 9, 2003

(51) Int. Cl. G06F 15/00

(52) U.S. Cl. 358/1.15; 358/1.16

(57) ABSTRACT

Representative embodiments provide for a control system for use with a thermal conditioning device, comprising a computer-accessible storage media including control data and a controller coupled to the thermal conditioning device and coupled to the computer-accessible storage media. The controller is configured to receive input corresponding to one of a geographic region or a language identification, and to selectively control the thermal conditioning device using at least a portion of the control data in correspondence to the input. A method for controlling a thermal conditioning device includes receiving input corresponding to one of a geographic region or a language identification, and selectively reading control data in response to the input. The method further includes selectively controlling the thermal conditioning device in response to the selectively read control data.

### BACKGROUND

Imaging apparatuses may selectively form images on sheet media through the application and subsequent heat-fixing of a corresponding imaging substance. Non-limiting examples of such imaging apparatuses include laser printers, light-emitting diode (LED) printers, ink-jet printers etc. Such imaging apparatus can be incorporated into dedicated printers, photocopies, facsimile machines, and so-called “all-in-one” devices which incorporate two or more of the foregoing examples into a single device. The imaging apparatus may use a number of different kinds of sheet media such as, for example, various types of paper, transparency stock, postcard material, etc.

The process of heat-fixing the applied imaging substance (i.e., fusing of toner, drying of ink, etc) can result in a generally undesirable curling or warping of the imaged sheet media. The magnitude of this curling generally corresponds to the type of sheet media and the process parameters (i.e., temperature and/or heat exposure time, etc.) used to heat-fix the imaging substance to the sheet media. Accordingly, it is desirable to know characteristics of the sheet media in order to control the heat-fixing process to reduce curling or warping of the sheet media during the heat-fixing process.

### SUMMARY

One embodiment of the present invention provides for a control system for use with a thermal conditioning device. The control system includes a computer-accessible storage media including control data, and a controller coupled to the thermal conditioning device and to the computer-accessible storage media. The controller is configured to receive input corresponding to one of a geographic region or a language identification. The controller is further configured to selectively control the thermal conditioning device using at least a portion of the control data in correspondence to the input.

Another embodiment of the present invention provides a method for controlling a thermal conditioning device. The method includes receiving input corresponding to one of a geographic region or a language identification, and selectively reading control data in response to the input. The method further includes selectively controlling the thermal conditioning device in response to the selectively read control data.

### DESCRIPTION OF THE DRAWINGS

FIG. 1 is a block diagram depicting an imaging apparatus in accordance with an embodiment of the present invention.

FIG. 2 is a block diagram depicting a data table in accordance with the embodiment of FIG. 1.

FIG. 3 is a block diagram depicting an imaging apparatus in accordance with another embodiment of the present invention.

FIG. 4 is a flowchart depicting a method of controlling an imaging apparatus in accordance with yet another embodiment of the present invention.

### DETAILED DESCRIPTION

In representative embodiments, the present teachings provide methods and apparatus for selectively controlling a thermal conditioning device of an imaging apparatus using look-up table data that has been cross-referenced by way of a geographic region or a language selection input from a user. This arrangement allows sheet media information to be used to control the heat-fixing process, without the need for media sensors, as described above.

The present teachings can be generally summarized as follows: Control systems (i.e., controllers) and methods for control are provided for use with imaging apparatuses. Each controller includes a data table including a plurality of data records, each including mutually associated geographic region data, language identifier data, media type data, and one or more control data (coefficient) entries. Each controller is configured to selectively designate or flag a particular one of the data records in response to a user input. The user input generally corresponds to one of the geographic region data, the language identifier data, or the media type data.

Each of the controllers then selectively uses the control data thereafter to control a thermal conditioning device (i.e., fuser, dryer, etc.) during the processing of print jobs received by the control system (controller), typically from a user computer coupled to the associated imaging apparatus. Certain embodiments of the controllers are configured to receive and/or update the data table at some time post-manufacture, by way of suitable software and/or Internet-based data resource communication. In other embodiments of the present invention, the controller includes (receives) the data table at the time of original manufacture. Similarly, some embodiments of the present invention include controllers that function in accordance with a computer-executable program code that is received and/or updated at some post-manufacture time. Still other embodiments of the present invention include the computer-executable program code at the time of manufacture.

In any case, each controller permits the control of a thermal conditioning device such that curling or other similar deformation of imaged sheet media is substantially reduced from what would otherwise occur, based upon a geographic region or language identification and without requiring a user or sensor to input specific information related to the type of sheet media being used.

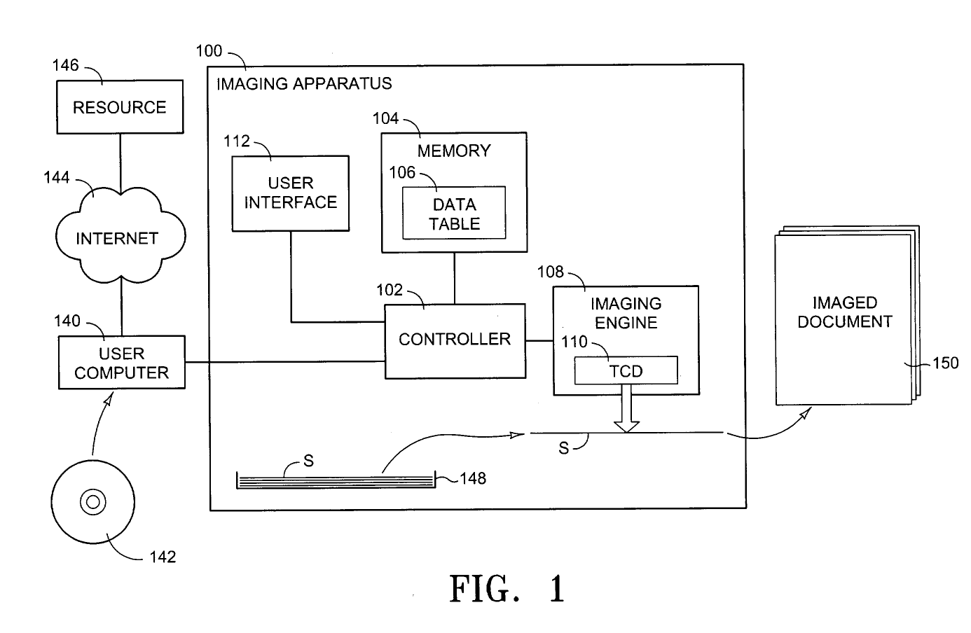

Turning now to FIG. 1, a block diagram depicts an imaging apparatus 100 in accordance with an embodiment of the present invention. The imaging apparatus 100 includes a controller 102. The controller 102 can be defined by any suitable controller that is configured to control typical normal operation of the imaging apparatus 100. As such, the controller 102 can include, for example: analog, digital and/or hybrid electronic circuitry; a state machine; a dedicated-purpose digital controller; etc. Further elaboration of the controller 102 is progressively provided hereafter.

The imaging apparatus 100 also includes a computer-accessible storage media 104. The computer-accessible storage media 104 is coupled in data communication with the controller 102. As depicted in FIG. 1, the computer-accessible storage media 104 is a solid-state memory. Other forms of suitable computer-accessible storage media 104 can also be used, such as a hard drive, an optical or magnetic memory medium, etc. The computer-accessible storage media 104 is configured to selectively store data and to retrieve, delete, and/or change the stored data in response to corresponding communication with the controller 102. Thus, the controller 102 and the computer-accessible storage media 104 are cooperatively coupled in a selectively controlled, data storage and retrieval relationship, and can be collectively referred to as a control system.

The computer-accessible storage media 104 includes a data table 106. The data table 106 includes data, and is further elaborated hereafter.

The imaging apparatus 100 includes an imaging engine 108. The imaging engine 108 is coupled in signal communication with the controller 102 and is selectively controllable thereby. The imaging engine 108 includes a thermal conditioning device (hereafter, TCD) 110. The imaging engine 108 is generally configured to be capable of selectively forming images on a sheet media “S”, using the TCD 110, in response to corresponding control signals from the controller 102. The imaging engine 108 can be defined by a laser imaging engine, a light-emitting diode (LED) imaging engine, an ink-jet imaging engine, etc.

In certain embodiments of the imaging apparatus 100 in which the imaging engine 108 is defined by a laser imaging engine or an LED imaging engine, the TCD 110 is generally defined by a fuser configured to fuse toner applied to a sheet media S by the imaging engine 108 under the control of the controller 102. In other embodiments of the imaging apparatus 100 in which the imaging engine 108 is defined by a ink-jet imaging engine, the TCD 110 is generally defined by a dryer configured to dry an imaging substance (i.e., “ink”) applied to a sheet media S by the imaging engine 108 under the control of the controller 102.

Regardless of the particular embodiment of the imaging engine 108, the associated TCD 110 is configured to include at least one operating parameter that is selectively controllable by the controller 102 such as, for example: heating temperature or power; sheet media contact time (commonly referred to as ‘dwell’); sheet media contact pressure; etc. Further elaboration of the TCD 110 is provided hereafter.

The imaging apparatus 100 further includes a user interface 112. The user interface is coupled in signal and data communication with the controller 102. The user interface 112 is configured to permit various user inputs related to the typical operation of the imaging apparatus 100 to the controller 102, and to permit the controller 102 to provide operating status and other information regarding the imaging apparatus 100 to a user. The user interface 112 can include, for example, an electronic display, indicating lights, an audible alarm or enunciator, push buttons and/or a keypad, etc., or any suitable combination of these or other elements (not shown, respectively) configured to facilitate the communication of operative information between a user and the controller 102.

The imaging apparatus 100 can further include any number of other cooperative devices or elements (not shown), as desired for typical operation. Non-limiting examples of such devices or elements include power supplies, sheet media transporting and routing mechanisms, reservoirs for ink, toner and/or sheet media, sensing devices, sheet media support trays, etc. One of skill in the art can appreciate that any number of these or other device and/or elements can be selectively included in a particular embodiment of the imaging apparatus 100, and that further elaboration is not necessary for purposes herein.

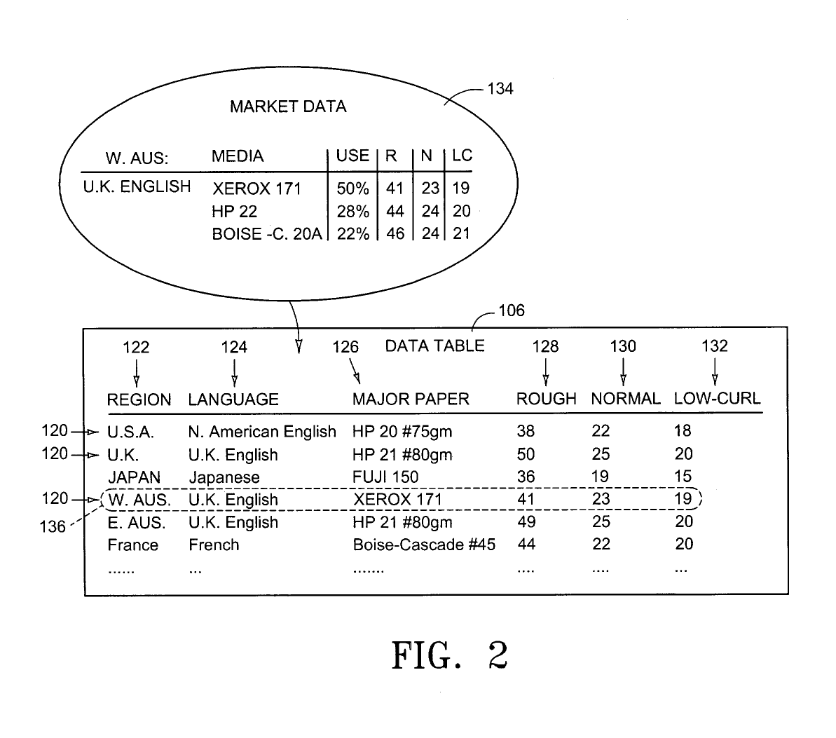

Reference is now additionally directed to FIG. 2, which depicts the data table 106 of the imaging apparatus 100 of FIG. 1. The data table 106 includes a plurality of data records 120, each depicted in FIG. 2 as a row of mutually-associated (i.e., corresponding, or correlated) data and coefficient types. Each data record 120 includes a geographic region data entry 122, a language identifier data entry 124, a paper type (i.e., sheet media) data entry 126, a rough-finish coefficient 128, a normal-finish coefficient 130, and a low-curl-finish coefficient 132. The coefficients 128, 130 and 132 are collectively referred to herein as control data, and represent substantially optimized operating coefficients for use in controlling the TCD 110 of the imaging apparatus 100. It will be appreciated that not all of the entries depicted in the data table 106 of FIG. 2 are required, and that fewer or additional entries can be provided, as will become apparent in the following description.

Each of the different data entries 122, 124 and 126 within a particular data record 120 is usable by the controller 102 to cross-reference to the mutually-associated coefficients 128, 130 and/or 132 for use in controlling the TCD 110 of the imaging engine 108. Further elaboration of the use of the data table 106 by the controller 102 is provided hereafter in regard to the normal operation of the imaging apparatus 100.

Further depicted in FIG. 2 is an exemplary data matrix 134. The exemplary data matrix 134 is assumed to depict market-share data for three different kinds of sheet media consumed within a geographic region designated as Western Australia (“W. AUS.”). As depicted in the data matrix 134, the representative language identifier for that geographic region is “U.K. ENGLISH”, while the media type “XEROX 171” represents the majority market share at fifty percent. Further depicted in the matrix 134 are rough-finish (“R”), normal-finish (“N”), and a low-curl-finish (“LC”) coefficients of forty-one, twenty-three, and nineteen, respectively, which are mutually associated with the majority media type “XEROX 171” and the language identifier “U.K. ENGLISH” for Western Australia (“W. AUS.”).

The plurality of data records 120 of the data table 106 includes a particular data record (hereafter, exemplary record) 136, which includes all of the data entries and coefficients (i.e., control data) associated with the majority media type “XEROX 171” of the exemplary market data matrix 134. Furthermore, the other data records 120 within the data table 106 respectively include similar associated data 122, 124 and 126, and coefficients 128, 130 and 132 which correspond to a majority market-share (or otherwise substantially prevailing or selected) sheet media type for each of the geographic regions 122 represented within the data table 106.

Typical normal operation of the imaging apparatus 100 is as follows. To begin, it is assumed that the imaging apparatus 100 is being commissioned or placed in service as a substantially new entity. As such, it is further assumed that the computer-accessible storage media (i.e., memory) 104 is configured to receive, but does not yet include, the data table 106. The imaging apparatus 100 is then coupled in data communication with a user computer 140. Next, initialization (i.e., commissioning, or start-up) software 142 including the data table 106 and a program code (not shown) corresponding to the initialization of the imaging apparatus 100 is introduced to the user computer 140. Such initialization software 142 can be in the form of a CD-ROM, a magnetic diskette, a magnetic tape, or any other suitable computer-accessible storage format that is typically provided with the imaging apparatus 100 at the time of purchase. It will be appreciated that the user computer 140 need not be in direct communication with the imaging apparatus, and can be a computer on a network to which the computer 140 and the imaging apparatus 100 are both connected.

In an alternative embodiment, the user computer 140 is coupled in data communication with a data resource 146 by way of an Internet connection 144, and such initialization software (i.e., program code, not shown) including the data table 106 is retrieved thereby from the data resource 146 for use by the user computer 140. Other suitable methods and apparatus for providing the initialization software to the user computer 140 can also be used.

In any case, the user computer 140 uses the initialization software (i.e., associated program code) to communicate the data table 106 to the controller 102, which in turn stores the data table 106 in the computer-accessible storage media 104.

Thereafter, the user computer 140, under the program code control of the initialization software 142, queries a user to provide a user input corresponding to the geographic region in which the imaging apparatus 100 is to be used. In another embodiment, the user computer 140, under similar software 142 control, queries a user to provide a user input corresponding to a language identification for use with the imaging apparatus 100. The user computer 140 then provides the user input (geographic region or language identification) to the controller 102 of the imaging apparatus 100. For purpose of example, it is assumed that the user input corresponds to the Western Australia geographic region. The controller 102 then uses the user input to identify and flag, or set a pointer to, the exemplary data record 136 within the data table 106 stored in the computer-accessible storage media 104.

Additional initialization or setup of the imaging apparatus 100 may also be completed, in accordance with the particular initialization configuration presently in use. Thereafter, the imaging apparatus 100 is considered ready for normal operation with the user computer 140.

At some time thereafter, the user computer 140 provides an electronic document file (i.e., a print job) to the controller 102 of the imaging apparatus 100. In other variations the source of the print job can be from a document scanner (as in a photocopier configuration), or via a telephonic transmission (as in a facsimile configuration), either of which can be incorporated directly into the imaging apparatus 100. The controller 102 then access the flagged (exemplary) data record 136 of the data table 106, and reads the appropriate coefficient or coefficients 128, 130 and/or 132 thereof, in correspondence to the particular instructions of the print job. For purposes of this example, it is assumed that the print job calls for a low-curl-finish to be used during the processing of the print job. The controller 102 then reads the low-curl-finish coefficient 132 of the exemplary data record 136.

The controller 102 then causes sheet media “S” to be drawn from an input tray 148, one sheet of media S at a time, and routed to the imaging engine 108. The controller 102 then causes the imaging engine 108 to selectively form images on the sheets of media S in accordance with the print job. Furthermore, the controller 102 uses the low-curl-finish coefficient 132 of the exemplary data record 136 to selectively control one or more operating parameters of the thermal conditioning device (TCD) 110.

For purposes of ongoing example, it is assumed that the TCD 110 includes a variable-power heat source usable to fuse toner (not shown) to the sheet media S, under the control of the controller 102. As such, the controller 102 then establishes a power output setting (i.e., temperature) for the TCD 110 in correspondence to the exemplary low-curl-finish coefficient 132. This correspondence can be defined by any suitable mathematical function of the exemplary low-curl-finish coefficient 132, or can be in direct (i.e., proportional) relationship thereto.

The imaging apparatus 100 continues this process, substantially as described above, until all of the sheet media S are imaged by the imaging engine 108 and its TCD 110, in accordance with the print job pending in the controller 102. The resulting sheets of imaged media then define an imaged document 150, and the print job is considered complete.

In the exemplary operation described above it was assumed that the imaging apparatus 100 was in a new or pre-commissioned state at the beginning, and thus did not yet include the data table 106 within the computer-accessible storage media 104. In another embodiment the imaging apparatus 100 can be provided with the data table 106 intact within the computer-accessible storage media 104 at the time of manufacture. Such an embodiment of the imaging apparatus 100 is typically provided when a geographic region or language identification has been predefined (i.e., a corresponding record 120 is flagged or pointed), as a result, for example, of a known or likely geographic region of use. That is, certain embodiments of the imaging apparatus 100 can be predefined in response to intended areas of distribution (i.e., sales or marketing). Other factors can also be used in the predefining of particular embodiments of the imaging apparatus 100.

In still another embodiment of the imaging apparatus 100, the user interface 112 facilitates the user input corresponding to a geographic region or a language identification to the controller 102. The imaging apparatus 100 in this type of an embodiment is assumed to include the data table 106 within the computer-accessible storage media 104 prior to the user input. In this way an embodiment of the imaging apparatus 100 can be re-configured for use in correspondence with a new geographic region or language identification other than that which was previously defined.

In yet another embodiment of the imaging apparatus 100, the user interface 112 or the coupled user computer 140 is usable to permit a user search and selection of the particular data record 120 of the data table 106 that corresponds to the desired operation of the imaging apparatus 100. In this case the user input to the controller 102 specifically identifies and flags the desired data record 120 of the data table 106 by way of any of its particular data and coefficient contents 122-132, respectively.

In still another embodiment of the imaging apparatus 100 the data table 106 can be updated (i.e., selectively replaced) within the computer-accessible storage media 104, by way of a corresponding operation of the user computer 140, in conjunction with an update software package (such as, for example, software 142) or the data resource 146 and the Internet connection 144. Thus, as new marketing data (similar to that of the data matrix 134) become available, a correspondingly new data table 106 can be provided to the imaging apparatus 100.

In general, the imaging apparatus 100 includes a controller 102 that is configured to selectively cross-reference (that is, read) operative coefficients (control data) 128, 130, and 132 within the data table 106 in correspondence to an initial or subsequent user input related to a geographic region or language identification, and to selectively use one or more of those coefficients 128, 130 and/or 132 during the controlled operation of the TCD 110 of the imaging engine 108. The imaging apparatus 100 allows for the controlled operation of the thermal conditioning device 110 in correspondence to the most likely identity of the sheet media being imaged by the imaging engine 108 by virtue of regional sheet media marketing data. In this way the imaging apparatus 100 substantially reduces the undesired curling of sheet media imaged by the imaging apparatus 100, without unduly burdening a user with the need to specifically identify the type of sheet media being used.

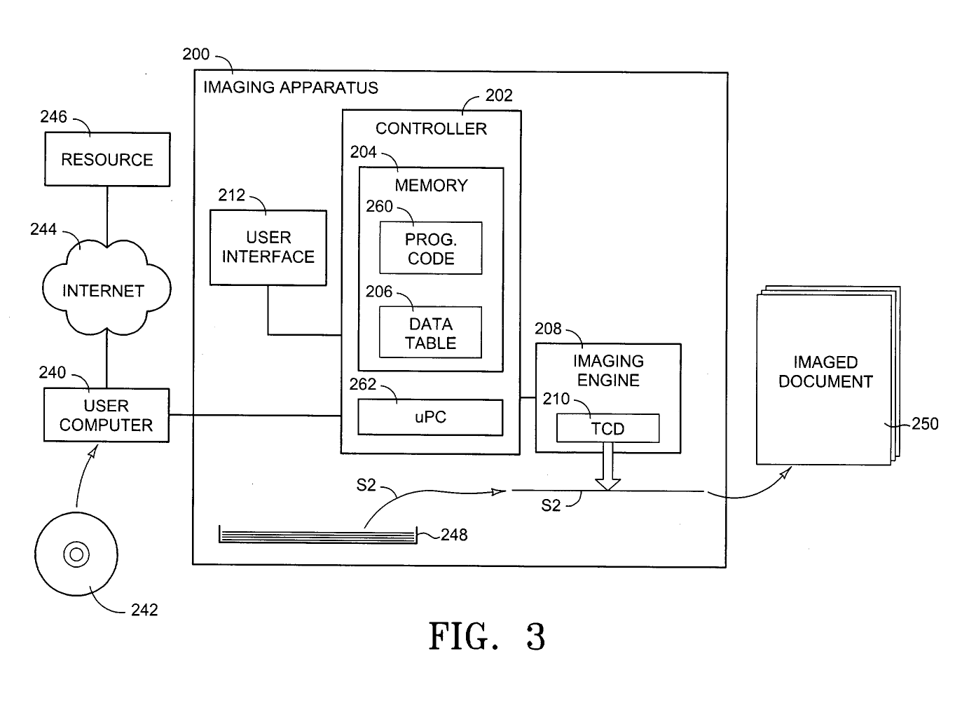

FIG. 3 is a block diagram depicting an imaging apparatus 200 in accordance with another embodiment of the present invention. The imaging apparatus 200 includes an imaging engine 208 having a thermal conditioning device 210, a user interface 212, and an input tray 248, which are defined, configured, and cooperative substantially as described above in regard to the imaging engine 108, the thermal conditioning device 110, the user interface 112, and the input tray 148, respectively, of the imaging apparatus 100 of FIG. 1.

The imaging apparatus 200 also includes a controller 202. The controller 202 includes a control processor 262. The control processor 262 is configured to control typical normal operation of the imaging apparatus 200 in response to executing a computer-executable program code (described in detail hereafter). The controller 202 includes a solid-state memory (hereinafter, memory) 204. The memory 204 is coupled in data communication with the control processor 262, and is generally configured to selectively store data and to retrieve, delete, and/or change the stored data in response to corresponding communication with the control processor 262.

The memory 204 of the controller 202 further includes a computer-executable program code 260. The program code 260 is configured to cause the control processor 262 to control normal operation of the imaging apparatus 200. Further elaboration of the program code 260 is provided hereafter. The memory 204 of the controller 202 also includes a data table 206. The data table 206 is substantially defined, configured, and cooperative as described above in regard to the data table 106 of the imaging apparatus 100 of FIG. 1.

It can be appreciated by one of skill in the imaging control arts that particular embodiments of the controller 202 can be substantially defined by any suitable microprocessor or microcontroller that includes the control processor 262 and the memory 204 described above, and which is further configured to be interfaced (i.e., suitably coupled) in controlling relationship with other the relevant devices and elements of the imaging apparatus 200. Thus, some embodiments of the controller 202 can be substantially defined by a unitary programmable integrated circuit.

As depicted in FIG. 3, the controller 202 is coupled in data communication with a user computer 240, and to a data resource 246 by way of an Internet connection 244 between the user computer 240 and the resource 246. The user computer 240, the data resource 246, and the Internet connection 244 are defined, configured, and cooperative substantially as described above in regard to the user computer 140, the data resource 146, and the Internet connection 144, respectively, as depicted in FIG. 1.

Furthermore, the imaging apparatus 200 can include any number of other cooperative devices and/or elements (not shown) as required or desired for normal operation of a particular embodiment of the imaging apparatus 200 such as, for example, those described above in regard to the imaging apparatus 100 of FIG. 1. One of skill in the imaging arts can appreciate that such devices and/or elements can be selectively included as desired within corresponding embodiments of the imaging apparatus 200 and that further elaboration is not required.

Typical operation of the imaging apparatus 200 is generally as follows. To begin, it is assumed that the imaging apparatus 200 is in a pre-commissioned state, and that the data table 206 is not yet stored within the memory 204. As such, the user computer 240 uses an initialization software media 242 and/or the resource 246 and the Internet connection 244 to provide the data table 206 to the controller 202. The control processor 262 then stores the data table 206 in the memory 204. Furthermore, the user computer 240 is used to provide the controller 202 with a user input corresponding to a geographic region or a language identification for use in cross-referencing the data table 206, substantially as described above in regard to normal operation of the imaging apparatus 100 of FIG. 1.

In another embodiment of the imaging apparatus 200 it is assumed that the program code 260 is not included in the memory 204 while the imaging apparatus 200 is in a pre-commissioned state. In this case, the program code 260 can be delivered to the user computer 240 by way of the initialization software media 242, or optionally from the data resource 246 by way of the Internet connection 244. Thereafter, the user computer 240 is then used to provide the program code 260 to the controller 202, which in turn stores it in the memory 204, prior to beginning normal operation of the imaging apparatus 200.

Once the data table 206 and/or the program code 260 are stored (i.e., installed) in the memory 204, and any other pre-defined initialization steps are completed in accordance with the initialization program code provided by the software media 242 and/or the data resource 246, the imaging apparatus 200 is considered commissioned and is ready for normal operation. At this point the imaging apparatus 200 is usable substantially as described above in regard to the imaging apparatus 100 of FIG. 1, resulting in an exemplary imaged document 250.

The imaging apparatus 200 includes a controller 202 that functions in accordance with the program code 260 to control the normal operation of the imaging apparatus 200. The program code 260, in accordance with the particular embodiment of the imaging apparatus 200, is provided to the imaging apparatus 200 at some time post-manufacture, and can be optionally updated from time-to-time as new versions of the program code 260 are generated. Furthermore, the data table 206 can be updated in a similar manner, through the use of software media (i.e., media 242) or an Internet-based resource (i.e., data resource 246).

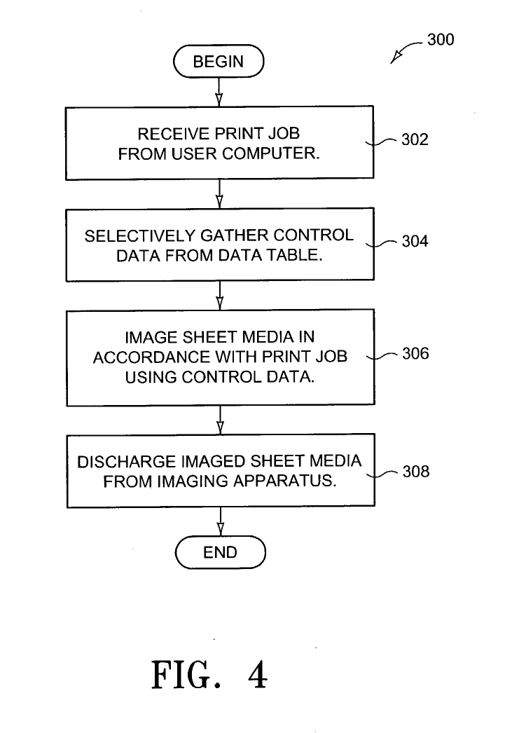

FIG. 4 is a flowchart depicting a method 300 for use in controlling imaging apparatus in accordance with yet another embodiment of the present invention. The method 300 is described in the context of the imaging apparatus 100 of FIG. 1 for clarity of understanding. However, it is to be understood that the method 300 is generally applicable to any embodiment of the present invention. While the method 300 describes particular method steps in a particular order of execution, it is to be understood that other variations of the method 300 can be used.

In step 302 of the flowchart 300 (FIG. 4), the controller 102 (FIG. 1) of the imaging apparatus 100 receives a print job (i.e., electronic document file) from the user computer 140.

In step 304 (FIG. 4), the controller 102 (FIG. 1) accesses the particular record 120 (FIG. 2) within the data table 106 that was previously flagged or pointed in correspondence to an earlier user input. For purposes of example, it is assumed that data record 136 (FIG. 2) is accessed. The controller 102 (FIG. 1) then selectively retrieves (i.e., reads, or gathers) one or more of the coefficients 128, 130, and/or 132 (FIG. 2) from the data record 136 of the data table 106, in accordance with the print job instructions.

In step 306 (FIG. 4), the controller 102 (FIG. 1) causes the imaging engine 108 and the associated TCD 110 to image one or more sheets of media S, in accordance with the print job and using the coefficient or coefficients (control data) 128, 130, and/or 132 (FIG. 2).

In step 308 (FIG. 4), the controller 102 (FIG. 1) causes the imaged sheet media to be suitably discharged from the imaging apparatus 100. The resulting imaged media thus define the imaged document 150. The method 300 is now considered complete.

While the above methods and apparatus have been described in language more or less specific as to structural and methodical features, it is to be understood, however, that they are not limited to the specific features shown and described, since the implementations herein disclosed comprise preferred forms of putting the invention into effect. The methods and apparatus are, therefore, claimed in any of their forms or modifications within the proper scope of the appended claims appropriately interpreted in accordance with the doctrine of equivalents.

We claim:

1. A control system for use with a thermal conditioning device, comprising:
a computer-accessible storage media including control data; and
a controller coupled to the thermal conditioning device and coupled to the computer-accessible storage media, wherein the controller is configured to receive input corresponding to one of a geographic region or a language identification, and wherein the controller is further configured to selectively control the thermal conditioning device using at least a portion of the control data in correspondence to the input.

2. The control system of claim 1, and further comprising a user interface coupled in data communication with the controller, and wherein the user interface is configured to permit a user to provide the input to the controller.

3. The control system of claim 1, and wherein the controller is further configured to receive the input from a user computer coupled in data communication with the controller.

4. The control system of claim 1, and wherein the computer-accessible storage media further includes a plurality of data records, and wherein each data record includes at least a portion of the control data and at least one of geographic region data corresponding to the control data, or language identification data corresponding to the control data.

5. The control system of claim 4, and wherein the controller is further configured to be selectively coupled in data communication with an Internet-based resource, and wherein the controller is further configured to selectively receive the plurality of data records from the Internet-based resource and to store the plurality of data records in the computer-accessible storage media in response to a corresponding input.

6. The control system of claim 4, and wherein the controller is further configured to be selectively coupled in data communication with a user computer, and wherein the controller is further configured to selectively receive the plurality of data records from the user computer and to store the plurality of data records in the computer-accessible storage media in response to a corresponding user command.

7. The control system of claim 1, and wherein the thermal conditioning device includes a fuser configured to selectively fuse a toner to a supporting sheet media in response to a corresponding control signal provided by the controller.

8. The control system of claim 1, and wherein the thermal conditioning device includes a dryer configured to selectively dry an imaging substance supported by a sheet media in response to a corresponding control signal provided by the controller.

9. The control system of claim 1, and wherein the controller is further configured to selectively control the thermal conditioning device in one of a rough mode, a normal mode, or a low curl mode using the portion of the control data corresponding to the input in response to a print job provided to the controller by a coupled source.

10. The control system of claim 1, and wherein the control data corresponds to a market share of a sheet media within a geographic region.

11. An imaging apparatus, comprising:
a controller;
an imaging engine including a thermal conditioning device and being coupled in signal communication with the controller, the imaging engine configured to selectively form images on sheet media in response to a corresponding control signal from the controller;
a computer-accessible storage media coupled in data communication with the controller and including a plurality of data records, wherein each data record includes control data; and
wherein the controller is configured to receive a user input corresponding to one of a geographic region or a language identification, and wherein the controller is further configured to selectively read control data from the plurality of data records in response to the user input, and to selectively control the thermal conditioning device using the selectively read control data.

12. The imaging apparatus of claim 11, and wherein the controller is further configured to receive the user input from one of a correspondingly coupled user interface or a correspondingly coupled user computer.

13. The imaging apparatus of claim 11, and wherein the controller is further configured to selectively receive the plurality of data records from a correspondingly coupled resource and to store the plurality of records in the computer-accessible storage media in response to a corresponding user input.

14. The imaging apparatus of claim 13, and wherein the controller is further configured such that the correspondingly coupled resource includes one of a user computer or an Internet-based resource.

15. The imaging apparatus of claim 11, and wherein the thermal conditioning device includes a fuser configured to selectively fuse a toner to a supporting sheet media in response to a corresponding control signal provided by the controller.

16. The imaging apparatus of clam 11, and wherein the thermal conditioning device includes a dryer configured to selectively dry an imaging substance supported by a sheet media in response to a corresponding control signal provided by the controller.

17. A computer-accessible storage media including a program code configured to be executed by a processor, the program code configured to cause the processor to:
receive input corresponding to one of a geographic region or a language identifier;
selectively read control data stored within a computer-accessible memory in correspondence to the input; and
selectively control a thermal conditioning device using the selectively read control data.

18. A computer-accessible storage media including a plurality of data records, wherein each of the data records includes mutually associated control data and language identification data, and wherein the control data is configured for use with an imaging apparatus.

19. A computer-accessible storage media including a plurality of data records, wherein each of the data records includes mutually associated control data and geographic region data, and wherein the control data is configured for use with an imaging apparatus.

20. A computer-accessible storage media including a plurality of data records, wherein each of the data records includes mutually associated control data and at least one of geographic region data, language identification data, or sheet media-type data respectively corresponding to a market share of a sheet media within a geographic region.

21. A method for controlling a thermal conditioning device, comprising:
receiving input corresponding to one of a geographic region or a language identification;
selectively reading control data in response to the input; and
selectively controlling the thermal conditioning device in response to the selectively read control data.

22. The method of claim 21, and further comprising receiving a print job to be imaged by an imaging apparatus including the thermal conditioning device, and wherein the control data is selectively read in response to the input and the print job.

23. The method of claim 21, and further comprising receiving and storing the control data in response to a corresponding user input.

24. The method of claim 21, and further comprising receiving the control data from an Internet-based resource.

25. The method of claim 21, and further comprising receiving the control data from a user computer.

26. The method of claim 21, and further comprising fusing a toner to a supporting sheet media.

27. The method of claim 21, and further comprising drying an imaging substance supported by a sheet media.

28. The method of claim 21, and further comprising selectively controlling the thermal conditioning device in one of a rough mode, a normal mode, or a low curl mode.

29. A controller for use with an imaging apparatus including a means for thermal conditioning, comprising:
means for storage of computer-accessible data for storing control data; and
means for controlling for selectively reading the control data in response to a user input corresponding to one of geographical region or a language identification, and selectively controlling the means for thermal conditioning in response to the read control data.
